(19) United States
(12) Patent Application Publication
(10) Pub. No.: US 2017/0257370 A1
(43) Pub. Date: Sep. 7, 2017

(54) CONTROLLED PROVISION OF CONTROLLED DATA

(71) Applicant: Siemens Aktiengesellschaft, Munchen (DE)

(72) Inventor: Jochen Bretschneider, Esslingen (DE)

(73) Assignee: Siemens Aktiengesellschaft, Munchen (DE)

(21) Appl. No.: 15/449,339

(22) Filed: Mar. 3, 2017

(30) Foreign Application Priority Data
Mar. 4, 2016 (EP) 16158708.4

(51) Int. Cl. H04L 29/06; G06F 3/06

(52) U.S. Cl. CPC H04L 63/10; G06F 3/0623; G06F 3/0637; G06F 3/0647; G06F 3/067

(57) ABSTRACT

A computer system includes a control device for controlling an industrial technical process, a logic unit and a memory device. The control device controls the industrial technical process in an operating cycle. It temporarily stores process data in the memory device when controlling the industrial technical process in an operating cycle. The logic unit accepts a request for the process data from an external computer outside of the computer system via an interface to a computer network. The logic unit transfers the process data stored in the memory device to the external computer in accordance with the request in an event of the request fulfilling an access condition. Otherwise, the logic unit preprocesses the process data stored in the memory device, so that the preprocessed process data have a reduced information content by a comparison with the stored process data.

### CROSS-REFERENCES TO RELATED APPLICATIONS

This application claims the priority of European Patent Application, Serial No. EP16158708.4, filed Mar. 4, 2016, pursuant to 35 U.S.C. 119(a)-(d), the content of which is incorporated herein by reference in its entirety as if fully set forth herein.

### BACKGROUND OF THE INVENTION

The invention relates to an operating method for a computer system, to a computer program, to a logic unit of a computer system, and to a computer system.

The following discussion of related art is provided to assist the reader in understanding the advantages of the invention, and is not to be construed as an admission that this related art is prior art to this invention.

Control devices such as numerical controllers, programmable logic control units or industry PCs have input/output interfaces that can be programmed by a programmer of the control device, so that there can be access from outside to the data of the respective control device. Examples of such interfaces are HMI-OA, OPC-UA, MT Connect, NCK-OA and more besides. Via the interfaces status information, process variables and other values can be read out from the control device, for example, and then further processed outside the control device. The further processing can, in particular, take place on computers that do not have any connection at all to the control device.

The external evaluation of such data is of considerable interest. Thus for example, on the basis of such data, future needs of the operator of the associated industrial technical processes can be established. It is also possible to establish optimizations of the operation of the industrial technical process.

In the prior art, there are no barriers within the control device or within the computer system of which the control device is a component that restrict access to the process data occurring within the control device. There is no deliberate influencing, i.e. an influencing controlled by the computer system of the data transferred to the external computer. Instead the process data, restricted only by the bandwidth of the link between the external computer and the computer system, is transferred to the external computer.

It would therefore be desirable and advantageous to address prior art shortcomings and to create opportunities to enable both a restriction of access to the process data and also an unrestricted access to the process data.

### SUMMARY OF THE INVENTION

According to one aspect of the present invention, an operating method for a computer system includes controlling by a control device of the computer system an industrial technical process in an operating cycle, thereby generating process data, at least temporarily storing the process data in a memory device of the computer system, a logic unit of the computer system receiving from an external computer outside of the computer system a request for the process data via an interface to a computer network, the logic unit transferring the process data stored in the memory device to the external computer in accordance with the request, when the request fulfils an access condition, and the logic unit preprocessing the process data stored in the memory device, when the request fails to fulfill the access condition, so that the preprocessed process data have a reduced information content in comparison with the stored process data, and the logic unit only transfers the preprocessed process data to the external computer in accordance with the request.

On the one hand, as it is also the case in the prior art, this enables the process data stored in the memory device to be transferred to the external computer without preprocessing, i.e. just as it is. However, this transfer is only made if the external computer has qualified itself for this. Otherwise, only the preprocessed process data, i.e. the process data with the reduced information content, is transferred to the external computer.

Preprocessing can be designed in various ways.

Thus, it is possible, for example, for the preprocessing to include filtering out of process data stored in the memory device relating to specific operating cycles. For example, the process data stored in the memory device for 4 of 5 operating cycles, respectively, or for 9 of 10 operating cycles, respectively, can be filtered out by the preprocessing. It is also possible, for example, to make the process data available only for shorter, self-contained periods of time and not to make the process data available for the remaining periods of time. For example, the process data can be made available just for five minutes per hour in each case or just for one day per week. The result that can be achieved, in particular, by making the data available for periods of time, where the periods of time, depending on the circumstances of the individual case, can range from seconds to minutes to beyond. A user of the external computer can better judge, whether the complete process data is relevant for them.

As an alternative, or in addition, it is possible for the preprocessing to include an averaging of process data stored in the memory device relating to a period of a number of operating cycles. For example, position values (actual values or setpoint values) can be averaged over 5 or 10 operating cycles. Naturally, other numbers of operating cycles are also possible.

As an alternative, or in addition, it is possible for the preprocessing to include the establishment of a value based on a number of process data stored in the memory device relating to a respective operating cycle. For a number of drives for example, only the overall power drawn by the drives, i.e. without dividing it up between the individual drives can be made available.

As an alternative, or in addition, it is possible for the preprocessing to include a rounding of process data stored in the memory device. Values can thus be made more imprecise. For example, a position acquired can be available before the preprocessing with an accuracy of 0.1 mm, after the preprocessing with only an accuracy of 1 mm.

As an alternative, or in addition, it is possible for the process data stored in the memory device to include, in addition to the acquired process data, an assigned name in each case, and for the preprocessing to include a complete or partial removal of the name. The efficiency of this measure can be increased by the preprocessing including a dynamic re-sorting of the preprocessed process data in relation to the process data stored in the memory device. For example, the order can be swapped for a number of drives. The result achieved by the dynamics of the re-sorting can be that a retroactive establishment of the correct order is made more difficult or even becomes impossible under some circumstances.

As an alternative, or in addition, it is possible for the preprocessing to include a filtering out of part of the process data relating to a specific operating cycle. For example, it is possible, that for a five-axis machine tool, only the values for 2 of the 5 axes will be made available.

It is possible, that the process data stored in the memory device will only be stored there temporarily. Advantageously, however, a time stamp is assigned to the process data held in the memory device and the process data in the memory device will continue to be archived. In this case, the data is never overwritten or is only overwritten in response to an express erase command specified to the computer system from outside or also after a sufficiently long waiting time has elapsed. The waiting time here generally corresponds to a period of several years.

The control device can be embodied as required. In particular, it is possible, for the control device to be embodied as a numerical controller, as a programmable logic control unit or as an industry PC.

It is possible for the logic unit and the control device to form one unit. As an alternative, it is possible, for the logic unit to be a different device from the control device.

According to another aspect of the present invention, a computer program embodied in a non-transitory computer readable medium includes a machine code which, when processed by a logic unit of a computer system, causes the logic unit to perform the steps of an operating method for the computer system.

According to still another aspect of the present invention, a logic unit of a computer system: includes a computer program, which is embodied in a non-transitory computer readable medium, with the computer program, when processed by the logic unit, causing the logic unit to perform the steps of an operating method for the computer system.

According to still another aspect of the present invention, a computer system includes a control device for controlling an industrial technical process, a memory device and a logic unit, with the logic unit including a computer program, which is embodied in a non-transitory computer readable medium and, when loaded into the logic unit of the computer system and executed by the logic unit causes the logic unit to perform the steps of the operating method for the computer system.

### BRIEF DESCRIPTION OF THE DRAWINGS

Other features and advantages of the present invention will be more readily apparent upon reading the following description of currently preferred exemplified embodiments of the invention with reference to the accompanying drawings, in which:

FIG. 1 shows a block diagram of a computer system according to the present invention;

FIG. 2 shows a flow diagram illustrating a control device of the computer system for controlling an industrial technical process;

FIG. 3 shows a data structure illustrating a storing of process data in the memory device;

FIG. 4 shows a flow diagram illustrating operation of a logic unit of the computer system when receiving a request for process data from an external computer;

FIG. 5 shows one example of preprocessing process data;

FIG. 6 shows another example of preprocessing process data;

FIG. 7 shows still another example of preprocessing process data;

FIG. 8 shows still another example of preprocessing process data;

FIG. 9 shows still another example of preprocessing process data; and

FIG. 10 shows still another example of preprocessing process data.

### DETAILED DESCRIPTION OF PREFERRED EMBODIMENTS

Throughout the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

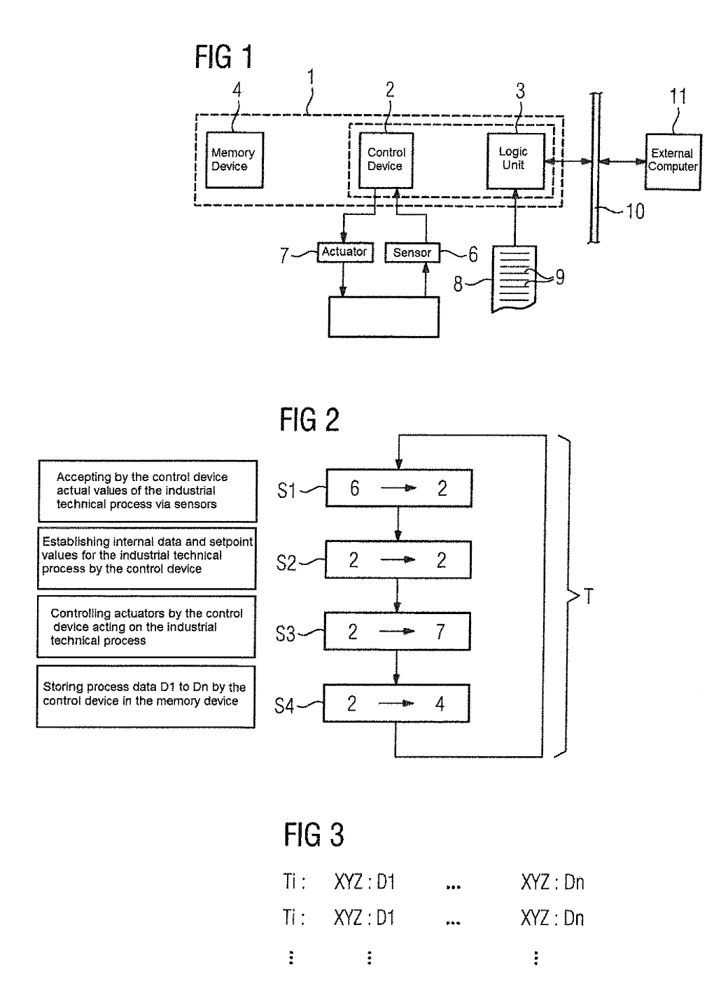

Turning now to the drawings and in particular to FIG. 1, there is shown a block diagram of a computer system 1 according to the present invention. The computer system 1 includes a control device 2, a logic unit 3 and a memory device 4. The control device 2 serves to control an industrial technical process 5, for example, of a machine tool, of a robot or of a production process. Accordingly, the control device 2 can be embodied as a numerical control, as a programmable logic control unit or as an industry PC for example.

The control device 2 controls the industrial technical process 5, in accordance with the diagram shown in FIG. 2, by iteratively executing steps S1 to S4 with an operating cycle T. In step S1, the control device 2 accepts actual values of the industrial technical process 5 via sensors 6. In step S2, the control device 2 establishes internal data and setpoint values for the industrial technical process 5. In step S3, the control device 2 controls actuators 7 acting on the industrial technical process 5 in accordance with the setpoint values established. In step S4, the control device 2 stores process data D1 to Dn in the memory device 4 (see FIG. 3). The process data D1 to Dn can involve actual values or setpoint values of the industrial technical process 5 or internal data of the control device 2. In many cases, the control device 2 assigns a time stamp Ti to the stored process data D1 to Dn. The respective time stamp Ti is characteristic of the operating cycle T, for which, the process data D1 to Dn is valid, i.e. depending on which data is involved for the operating cycle T, in which, the actual values were acquired, the internal data was established or the setpoint values were output to the actuators 7. This method of operation is especially of advantage when the process data D1 to Dn will be archived in the memory device 4.

In accordance with the block diagram in FIG. 1, it is possible for the logic unit 3 to be a device different from the control device 2. As an alternative, it is possible for the logic unit 3 and the control device 2 to form one unit. This is indicated in FIG. 1 by a dashed-line surrounding frame.

The logic unit 3 is programmed with a computer program 8. The computer program 8 includes machine code 9 that can be executed by the logic unit 3. The effect of the execution of the machine code 9 by the logic unit 3 is that the logic unit 3 operates in a way that is explained in greater detail below in conjunction with the further Figures.

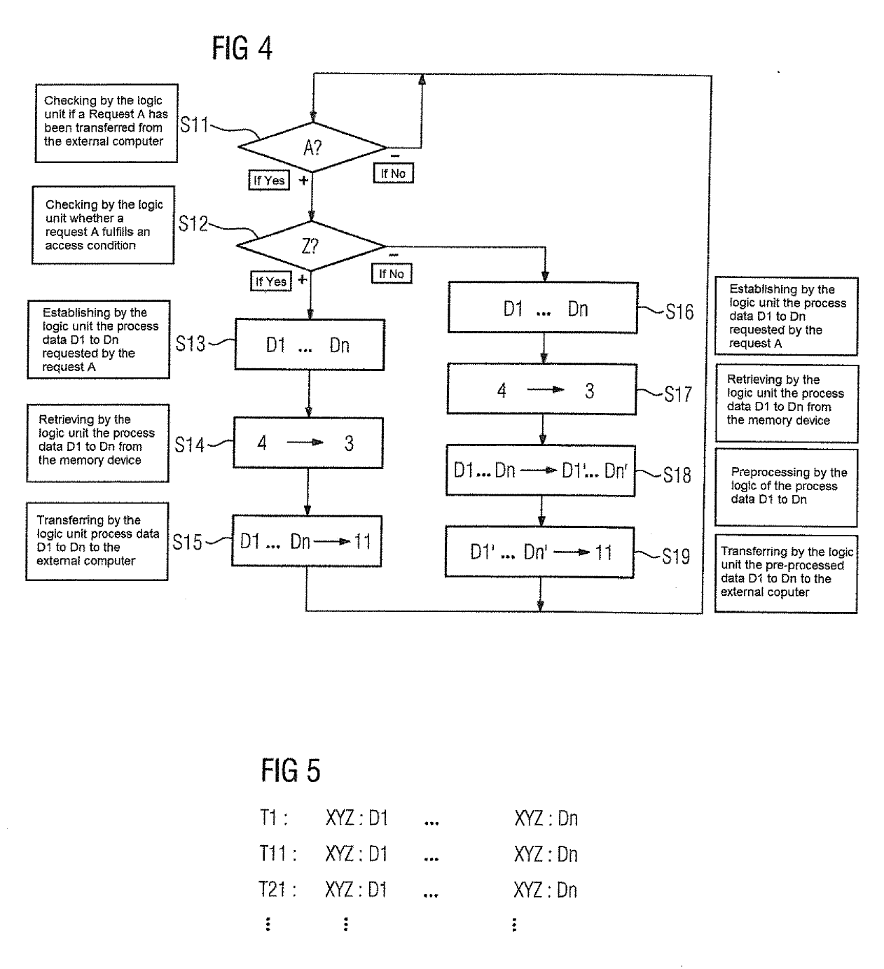

In accordance with the block diagram depicted in FIG. 1, the logic unit 3 is connected at least for some of the time to a computer 11 via an interface to a computer network 10 (for example a LAN or a WAN, especially the Internet). The computer 11 is located outside the computer system 1. It is therefore referred to below as an external computer 11. The logic unit 3 checks in accordance with the diagram in FIG. 4, in a step S11, whether a request A for the process data D1 to Dn has been transferred to it from the external computer 11. If it has, it accepts the data in step S11 and moves to step S12. Otherwise, the logic unit 3 stays at step S11. In step S12, the logic unit 3 checks whether the request A fulfills an access condition Z. If this is the case, the logic unit 3 moves to steps S13 to S15, otherwise to steps S16 to S19.

In step S13, the logic unit 3 establishes the process data D1 to Dn requested by the request A. In step S14, the logic unit 3 retrieves this process data D1 to Dn from the memory device 4. In step S15, the logic unit 3 transfers the corresponding process data D1 to Dn to the external computer 11 in accordance with the request A.

In step S16, the logic unit 3 establishes, just as in step S13, the process data D1 to Dn requested by the request A. In step S17, the logic unit 3 retrieves this process data D1 to Dn, just as in step S14, from the memory device 4. In step S18, the logic unit 3 undertakes a preprocessing of the process data D1 to Dn retrieved from the memory device 4. It thereby establishes preprocessed process data D1′ to Dn′. The preprocessing is such, that the preprocessed process data D1′ to Dn′, by comparison with the stored process data D1 to Dn, has a reduced information content. Possible preprocessings will be explained below. In step S19, the logic unit 3 transfers the preprocessed process data D1′ to Dn′ to the external computer 11 in accordance with the request A.

The process data D1 to Dn stored in the memory device 4 (even if the process data D1 to Dn is not assigned the respective time stamp Ti) is always related to a specific operating cycle T. The preprocessing can, for example, include the logic unit 3 filtering out process data D1 to Dn stored in the memory device 4 relating to specific operating cycles T. Purely by way of example, this is shown in FIG. 5 by the preprocessed process data D1′ to Dn′ only containing every tenth set of process data D1 to Dn.

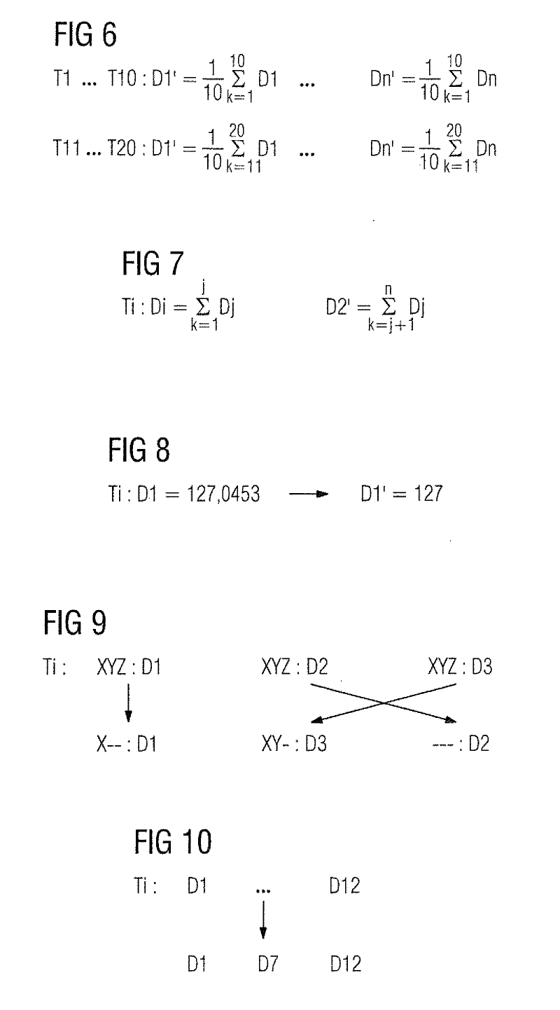

As an alternative or in addition, it is possible for the preprocessing, in accordance with the diagram shown in FIG. 6, to include the logic unit 3 undertaking an averaging in relation to the process data D1 to Dn stored in the memory device 4 over a period of a number of operating cycles T, purely by way of example, ten operating cycles T.

As an alternative or in addition, it is possible for the preprocessing, in accordance with the diagram shown in FIG. 7, to include the logic unit 3 establishing a value, for example the sum or the average value, for a number of items of process data D1 to Dn stored in the memory device 4, which however are all related to a specific operating cycle T. In this case, instead of the original process data D1 to Dn that is included in the established value, only the established value is transferred to the external computer 11.

As an alternative or in addition, it is possible for the preprocessing, in accordance with the diagram shown in FIG. 8, to include the logic unit 3 undertaking a rounding of process data D1 to Dn stored in the memory device 4. In this case, instead of the original process data D1 to Dn, only the rounded values D1′ to Dn′ are transferred to the external computer 11.

In many cases, the process data D1 to Dn stored in the memory device 4 in accordance with the diagram in FIG. 3, in addition to the process data D1 to Dn itself, includes an assigned name XYZ in each case. In this case the preprocessing, in accordance with the diagram shown in FIG. 9, can include the logic unit 3 completely or partially removing the name XYZ. In addition, the logic unit 3 in this case, in accordance with the diagram shown in FIG. 9, can also include a re-sorting in relation to the process data D1 to Dn stored in the memory device 4. In this case, the preprocessed process data D1′ to Dn′ thus does not have the same order as the process data D1 to Dn itself. If the re-sorting is undertaken, it is advantageously dynamic. The re-sorting thus varies from request A to request A and/or within a request A from process data D1 to Dn relating to a specific operating cycle T to process data D1 to Dn relating to another operating cycle T.

As an alternative or in addition, it is possible for the preprocessing, in accordance with the diagram shown in FIG. 10, to include the logic unit 3 only accepting some of the process data D1 to Dn stored in the memory device 4 as preprocessed process data D1′ to Dn′. Thus a partial filtering out of process data D1 to Dn is undertaken. The difference from the method of operation depicted in FIG. 5 lies in the fact that, within the framework of the method of operation of FIG. 10, the filtering out is done internally within process data D1 to Dn relating to a specific operating cycle T. Thus, for example, only the process data D1, D7 and D12 is transferred, but not the process data D2 to D6 and D8 to D11 and also, if present, D13, D14 etc.

The aforementioned possible preprocessings are independent of one another. They can be combined with one another as required.

In summary, the present invention discloses a computer system 1 which includes a control device 2 for control of an industrial technical process 5, a logic unit 3 and a memory device 4. The control device 2 controls the industrial technical process 5 in an operating cycle T. It stores process data D1 to Dn, which arises within the framework of controlling the industrial technical process 5 within the control device 2 with the operating cycle T, at least temporarily in the memory device 4. The logic unit 3 accepts a request A from an external computer 11 outside of the computer system 1 for the process data D1 to Dn via an interface to a computer network 10. In the event of the request A fulfilling an access condition Z, the logic unit 3 transfers the process data D1 to Dn stored in the memory device 4 to the external computer 11 in accordance with the request A. Otherwise the logic unit 3 preprocesses the process data D1 to Dn stored in the memory device 4, so that the preprocessed process data D1′ to Dn′ has a reduced information content compared to the stored process data D1 to Dn. It transfers only the preprocessed process data D1′ to Dn′ to the external computer 11 in accordance with the request A.

The present invention has many advantages. In particular a decision can be made by the logic unit 3 and thus on the side of the computer system 1 as to whether the process data D1 to Dn is to be made available to the external computer 11 (to expand: just as it is) or whether only the preprocessed process data D1′ to Dn′ is to be made available.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An operating method for a computer system, comprising the steps of:
controlling by a control device of the computer system an industrial technical process in an operating cycle, thereby generating process data;
at least temporarily storing the process data in a memory device of the computer system;
a logic unit of the computer system receiving from an external computer outside of the computer system a request for the process data via an interface to a computer network;
the logic unit transferring the process data stored in the memory device to the external computer in accordance with the request, when the request fulfils an access condition; and
the logic unit preprocessing the process data stored in the memory device, when the request fails to fulfill the access condition, so that the preprocessed process data have a reduced information content in comparison with the stored process data, and the logic unit only transfers the preprocessed process data to the external computer in accordance with the request.

2. The operating method of claim 1, wherein the step of preprocessing includes a filtering out of process data stored in the memory device relating to specific operating cycles.

3. The operating method of claim 1, wherein the step of preprocessing includes forming an average value of the process data stored in the memory device relating to a period of a number of operating cycles.

4. The operating method of claim 1, wherein the step of preprocessing includes establishing a value on a basis of several sets of process data that relating to corresponding operating cycles and are stored in the memory device.

5. The operating method of claim 1, wherein the step of preprocessing includes a rounding of the process data stored in the memory device.

6. The operating method of claim 1, wherein the process data stored in the memory device includes an assigned name, with the step of preprocessing including completely or partially removing the name.

7. The operating method of claim 6, wherein the step of preprocessing includes a dynamic re-sorting of the preprocessed process data compared to the process data stored in the memory device.

8. The operating method of claim 1, wherein the step of preprocessing includes a partial filtering out of process data relating to a specific operating cycle.

9. The operating method of claim 1, further comprising assigning a time stamp for the process data stored in the memory device, and archiving the process data in the memory device.

10. The operating method of claim 1, wherein the control device is a numerical control, a programmable logic control unit or an industry PC.

11. The operating method of claim 1, wherein the logic unit and the control device form a unit.

12. The operating method of claim 1, wherein the logic unit and the control device are separate units.

13. A computer program embodied in a non-transitory computer readable medium, said computer program comprising machine code which, when processed by a logic unit of a computer system, causes the logic unit to perform the steps of:
controlling by a control device of the computer system an industrial technical process in an operating cycle, thereby generating process data;
at least temporarily storing the process data in a memory device of the computer system;
the logic unit receiving from an external computer outside of the computer system a request for the process data via an interface to a computer network;
the logic unit transferring the process data stored in the memory device to the external computer in accordance with the request, when the request fulfils an access condition; and
the logic unit preprocessing the process data stored in the memory device, when the request fails to fulfill the access condition, so that the preprocessed process data have a reduced information content in comparison with the stored process data, and the logic unit only transfers the preprocessed process data to the external computer in accordance with the request.

14. A logic unit of a computer system, said logic unit comprising a computer program which is embodied in a non-transitory computer readable medium, wherein the computer program, when processed by the logic unit, causes the logic unit to perform the steps of:
controlling by a control device of the computer system an industrial technical process in an operating cycle, thereby generating process data;
at least temporarily storing the process data in a memory device of the computer system;
the logic unit receiving from an external computer outside of the computer system a request for the process data via an interface to a computer network;
the logic unit transferring the process data stored in the memory device to the external computer in accordance with the request, when the request fulfils an access condition; and
the logic unit preprocessing the process data stored in the memory device, when the request fails to fulfill the access condition, so that the preprocessed process data have a reduced information content in comparison with the stored process data, and the logic unit only transfers the preprocessed process data to the external computer in accordance with the request.

15. A computer system, comprising:
a control device for controlling an industrial technical process;
a memory device; and
a logic unit, said logic unit comprising a computer program which is embodied in a non-transitory computer readable medium, wherein the computer program, when loaded into the logic unit of a computer system and executed by the logic unit, causes the logic unit to perform the steps of:
controlling by a control device of the computer system an industrial technical process in an operating cycle, thereby generating process data;
at least temporarily storing the process data in a memory device of the computer system;
the logic unit receiving from an external computer outside of the computer system a request for the process data via an interface to a computer network;
the logic unit transferring the process data stored in the memory device to the external computer in accordance with the request, when the request fulfils an access condition; and
the logic unit preprocessing the process data stored in the memory device, when the request fails to fulfill the access condition, so that the preprocessed process data have a reduced information content in comparison with the stored process data, and the logic unit only transfers the preprocessed process data to the external computer in accordance with the request.
